(19) United States
(12) Patent Application Publication
(10) Pub. No.: US 2024/0191808 A1
(43) Pub. Date: Jun. 13, 2024

(54) Bi-Directional Ball Valve Drain Device

(71) Applicant: Joseph Culligan, Center Ossipee, NH (US)

(72) Inventor: Joseph Culligan, Center Ossipee, NH (US)

(21) Appl. No.: 18/513,887

(22) Filed: Nov. 20, 2023

Related U.S. Application Data
(60) Provisional application No. 63/431,858, filed on Dec. 12, 2022.

(51) Int. Cl. F16K 24/04

(52) U.S. Cl. CPC F16K 24/04

(57) ABSTRACT

A bi-directional ball valve drain device is provided. The device is comprised of a body that can be attached to a plumbing line between a feed and a fixture in order to allow a user to unilaterally drain both sides of the plumbing line on both sides of the device via a drain tube of the body. The flow of liquid into each side of the body can be controlled (i.e., allowed and inhibited) by a handle of the device.

### CROSS-REFERENCE TO RELATED APPLICATION

The present application claims priority to, and the benefit of, U.S. Provisional Application No. 63/431,858, which was filed on Dec. 12, 2022, and is incorporated herein by reference in its entirety.

### FIELD OF THE INVENTION

The present invention relates generally to the field of plumbing valves. More specifically, the present invention relates to a bi-directional ball valve drain device that can be attached to a plumbing line between a feed and a fixture in order to allow a user to unilaterally drain both sides of the plumbing line on both sides of the device. Accordingly, the present disclosure makes specific reference thereto. Nonetheless, it is to be appreciated that aspects of the present invention are also equally applicable to other like applications, devices, and methods of manufacture.

### BACKGROUND

Cutting into plumbing pipes that are still filled with fluid can result in an unanticipated and sizable mess if they are not drained correctly beforehand. In many situations, technicians or homeowners may find themselves in a position where they need to drain the entire plumbing system in order to carry out repairs or installations. This process can be both tedious and time-consuming.

Therefore, there exists a long-felt need in the art for an improved plumbing valve. There also exists a long-felt need in the art for a bi-directional ball valve drain device. There also exists a long-felt need in the art for a bi-directional ball valve drain device that allows a user to drain a plumbing system. More specifically, there exists long-felt need in the art for a bi-directional ball valve drain device that allows a user to drain a plumbing system without requiring a user to drain an entire plumbing system.

The subject matter disclosed and claimed herein, in one embodiment thereof, comprises a bi-directional ball valve drain device. The device is comprised of a body that can be attached to a plumbing line between a feed and a fixture in order to allow a user to unilaterally drain both sides of the plumbing line on both sides of the device via a drain tube of the body. The flow of liquid into each side of the body can be controlled (i.e., allowed and inhibited) by a handle of the device.

In this manner, the bi-directional ball valve drain device of the present invention accomplishes all the forgoing objectives and provides an improved plumbing valve. During use, the device allows a user to drain a plumbing system. More specifically, the device allows a user to drain a plumbing system without requiring a user to drain an entire plumbing system.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bi-directional ball valve drain device. The device is primarily comprised of a body comprised of a first opening and a second opening, at least one handle, and at least one drain tube and cap. During use, the device can be positioned in a point in a plumbing line between a feed and a fixture (such as but not limited to a sink, a toilet, etc.), wherein the device allows a user to drain each side of the plumbing line on each side of the device independently. As a result, a user need not drain the entire plumbing line in order to drain a portion of the line.

The body is comprised of at least two ends. Both ends are comprised of at least one opening that may be any diameter/size to receive any type and size of piping/tubing known in the art. In one embodiment, the openings may be a threaded opening comprised of male and/or female threads.

The device is also comprised of at least one handle that can be turned to inhibit flow through the body from the first end to the second end. The body is also comprised of at least one drain tube preferably positioned between the first end and second end. The tube receives at least one cap which prevents liquid from exiting the tube when not desired. A user can attach a secondary plumbing pipe/fitting/tubing to the tube for drainage.

The present invention is also comprised of a method of using the device. First, a device is provided comprised of a body comprised of at least one train tube, at least one cap, and at least one handle, and at least a first end and a second end—each end comprised of at least one opening. Then, the device 100 can be attached to a plumbing waterline line and can be positioned between a feed and a fixture within the line. More specifically, the piping/tubing from the feed side attaches to the first opening and the piping/tubing from the fixture side attaches to the second opening. Then, a user can rotate the handle at least one, but preferably 90-degrees (clockwise) which shuts off water to the device from the fixture side. Then, the cap can be removed from the drain tube to allow water/liquid to drain from the feed side. After drainage is complete, the cap can be replaced and the handle can be rotated 180-degrees (counterclockwise) in order to shut off the flow of water from the feed side. Then, the cap can be removed again and the fixture side can be drained. After fixture side drainage has occurred, the cap can be replaced and the handle can be rotated 90-degrees clockwise to render the device in line with the feed side and fixture side to allow water/liquid to flow completely through the device from the feed to the fixture.

Accordingly, the bi-directional ball valve drain device of the present invention is particularly advantageous as it provides an improved plumbing valve. During use, the device allows a user to drain a plumbing system. More specifically, the device allows a user to drain a plumbing system without requiring a user to drain an entire plumbing system. In this manner, the bi-directional ball valve drain device overcomes the limitations of existing plumbing valves and plumbing line drainage systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bi-directional ball valve drain device of the present invention in accordance with the disclosed architecture;

FIG. 2 illustrates a side view of one potential embodiment of a bi-directional ball valve drain device of the present invention in accordance with the disclosed architecture;

FIG. 3 illustrates a flowchart of a method of using one potential embodiment of a bi-directional ball valve drain device of the present invention in accordance with the disclosed architecture; and

FIG. 4 illustrates a perspective view of a handle and flow-inhibiting structure of one potential embodiment of a bi-directional ball valve drain device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved plumbing valve. There also exists a long-felt need in the art for a bi-directional ball valve drain device. There also exists a long-felt need in the art for a bi-directional ball valve drain device that allows a user to drain a plumbing system. More specifically, there exists long-felt need in the art for a bi-directional ball valve drain device that allows a user to drain a plumbing system without requiring a user to drain an entire plumbing system.

The present invention, in one exemplary embodiment, is comprised of a bi-directional ball valve drain device primarily comprised of a body comprised of a first opening and a second opening, at least one handle, and at least one drain tube and cap. During use, the device can be positioned in a point in a plumbing line between a feed and a fixture (such as but not limited to a sink, a toilet, etc.). Then, the device allows a user to drain each side of the plumbing line on each side of the device independently. As a result, a user need not drain the entire plumbing line in order to drain a portion of the line.

The body is comprised of at least two ends. Both ends are comprised of at least one opening that may be any diameter/size to receive any type and size of piping/tubing known in the art. In one embodiment, the openings may be a threaded opening comprised of male and/or female threads.

The device is also comprised of at least one handle. The handle can be turned to inhibit flow through the body from the first end to the second end. The body is also comprised of at least one drain tube preferably positioned between the first end and second end which receives at least one cap. The cap prevents liquid from exiting the tube when not desired. A user can also attach a secondary plumbing pipe/fitting/tubing to the tube for drainage.

The present invention is also comprised of a method of using the device. First, a device is provided comprised of a body comprised of at least one train tube, at least one cap, and at least one handle, and at least a first end and a second end—each end comprised of at least one opening. Then, the device 100 can be attached to a plumbing waterline line and can be positioned between a feed and a fixture within the line. More specifically, the piping/tubing from the feed side attaches to the first opening and the piping/tubing from the fixture side attaches to the second opening. Then, a user can rotate the handle at least one, but preferably 90-degrees (clockwise) which shuts off water to the device from the fixture side. Then, the cap can be removed from the drain tube to allow water/liquid to drain from the feed side. After drainage is complete, the cap can be replaced and the handle can be rotated 180-degrees (counterclockwise) in order to shut off the flow of water from the feed side. Then, the cap can be removed again and the fixture side can be drained. After fixture side drainage has occurred, the cap can be replaced and the handle can be rotated 90-degrees clockwise to render the device in line with the feed side and fixture side to allow water/liquid to flow completely through the device from the feed to the fixture.

Accordingly, the bi-directional ball valve drain device of the present invention is particularly advantageous as it provides an improved plumbing valve. During use, the device allows a user to drain a plumbing system. More specifically, the device allows a user to drain a plumbing system without requiring a user to drain an entire plumbing system. In this manner, the bi-directional ball valve drain device overcomes the limitations of existing plumbing valves and plumbing line drainage systems known in the art.

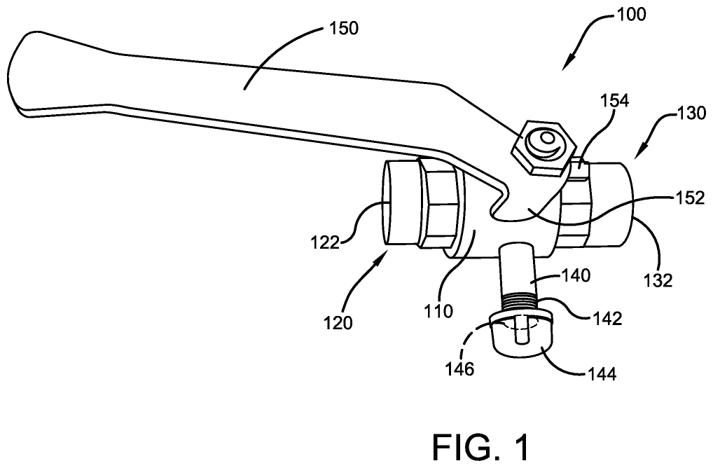

Referring initially to the drawings, FIG. 1 illustrates a perspective view of one potential embodiment of a bi-directional ball valve drain device 100 of the present invention in accordance with the disclosed architecture. The device 100 is primarily comprised of a body 110 comprised of a first opening 122 and a second opening 132, at least one handle 150, and at least one drain tube 140 and cap 144. During use, the device 100 can be positioned in a point in a plumbing line between a feed and a fixture (such as but not limited to a sink, a toilet, etc.). The device 100 allows a user to drain each side of the plumbing line on each side of the device 100 independently. As a result, a user need not drain the entire plumbing line in order to drain a portion of the line.

All components of the device 100 may be made from any plumbing-grade material known in the art such as but not limited to brass, copper, metal, cast-iron, etc. The body 110 is comprised of at least two ends 120,130. The first end 120 is comprised of at least one opening 122. The opening 122 may be any diameter/size to receive any type and size of piping/tubing known in the art. In one embodiment, the opening 122 may be a threaded opening comprised of male and/or female threads.

The second end 130 is comprised of at least one opening 132. The opening 132 may be any diameter/size to receive any type and size of piping/tubing known in the art. In one embodiment, the opening 132 may be a threaded opening comprised of male and/or female threads.

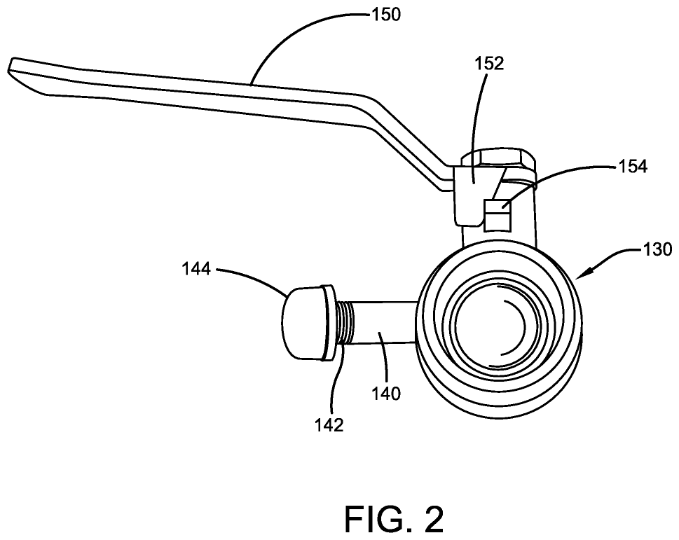

The device 100 is also comprised of at least one handle 150. The handle 150 can be turned, in one embodiment 90-degrees, in order to inhibit flow through the body 110 from the first end 120 to the second end 130. The body 110 is preferably comprised of at least one handle stop 154 that extends outwards from the body 110. The handle 150 is comprised of at least one tab 152 that contacts the stop 154 once the handle 150 is rotated 90-degrees, as seen in FIG. 2. As a result, the stop 154 prevents the handle 150 from over-rotating. It should be appreciated that the handle 150 may turn at least one 1-degree in order to allow or inhibit flow from the first end 120 to the second end 130. In one embodiment, the handle 150 is comprised of two tabs 152 on each side of the handle 150. In this embodiment, the body 110 has two stops 154, one stop 154 on each side of the handle 150, wherein turning the handle 150 clockwise or counterclockwise forces the tab 152 on either side of the handle 150 to contact either stop 154 to stop rotation of the handle 150.

The body 110 is also comprised of at least one drain tube 140. The tube 140 is preferably positioned between the first end 120 and second end 130, but may be positioned anywhere on the body 110. The tube 140 receives at least one cap 144 which prevents liquid from exiting the tube 140 when not desired. The tube 140 may be comprised of at least one fastener, such as but not limited to a plurality of male or female threads, that engage at least one fastener 146 of the cap 144, which may include but is not limited to a plurality of male or female threads. The fastener 142 also allows a user to attach a secondary plumbing pipe/fitting/tubing for drainage.

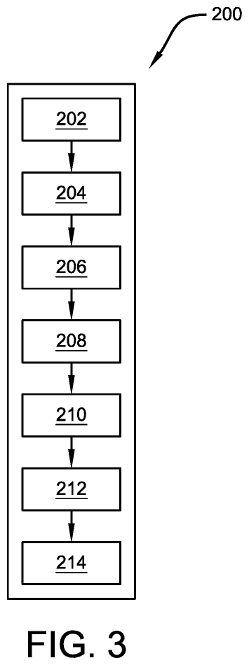

The present invention is also comprised of a method of using 200 the device 100, as seen in FIG. 3. First, a device 100 is provided comprised of a body 110 comprised of at least one train tube 140, at least one cap 144, and at least one handle 150, and at least a first end 120 and a second end 130—each end 120,130 comprised of at least one opening 122,132, [Step 202]. Then, the device 100 can be attached to a plumbing waterline line and can be positioned between a feed and a fixture within the line [Step 204]. More specifically, the piping/tubing from the feed side attaches to the first opening 122 and the piping/tubing from the fixture side attaches to the second opening 132. In said position, the handle 150 preferably faces (and may be parallel to) the feed side. Then, a user can rotate the handle at least one, but preferably 90, degrees (clockwise) which shuts off water to the device 100 from the fixture side [Step 206]. Then, the cap 144 can be removed from the drain tube 140 to allow water/liquid to drain from the feed side [Step 208]. After drainage is complete, the cap 144 can be replaced and the handle 150 can be rotated 180-degrees (counterclockwise) in order to shut off the flow of water from the feed side [Step 210]. Then, the cap 144 can be removed again and the fixture side can be drained [Step 212]. After fixture side drainage has occurred, the cap 144 can be replaced and the handle 150 can be rotated 90-degrees clockwise to render the device 100 in line with the feed side and fixture side to allow water/liquid to flow completely through the device 100 from the feed to the fixture [Step 214].

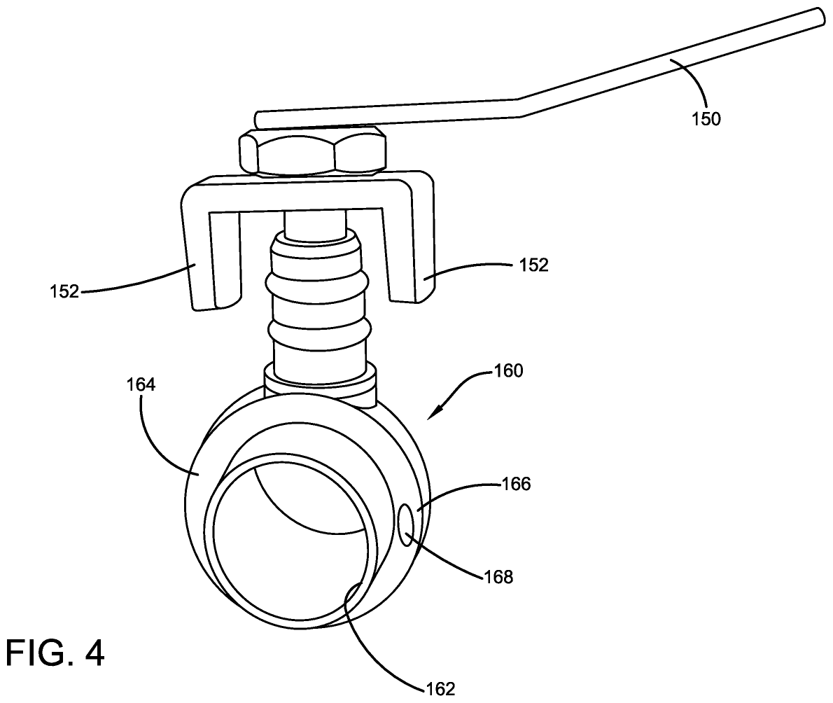

More specifically, the handle 150 controls at least one flow-inhibiting structure 160 positioned within the body 110. The structure 160 directs flow through the body 110. The structure 160 is preferably generally cylindrical in shape, but may be any shape. In said embodiment, the structure 160 is comprised of at least one opening 162 that allows liquid to pass completely through the structure 160, and thus through the entire body 110, as seen in FIG. 4. The structure 160 may be comprised of at least two side walls 164,166. The second side wall 166 may be comprised of at least one opening 168. When the handle 150 is turned to block flow from one end 120,130 of the body 110, the first wall 164 faces the opening 122,132 of said end 120,130. In this position, the opening 162 faces the drain tube 140. Further, the opening 168 of the second side wall 166 allows liquid from the other end 120,130 to still flow through the structure 160 and out the drain tube 140, thus allowing unilateral draining of the plumbing system.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bi-directional ball valve drain device” and “device” are interchangeable and refer to the bi-directional ball valve drain device 100 of the present invention.

Notwithstanding the forgoing, the bi-directional ball valve drain device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bi-directional ball valve drain device 100 as shown in the FIGS. are for illustrative purposes only, and that many other sizes and shapes of the bi-directional ball valve drain device 100 are well within the scope of the present disclosure. Although the dimensions of the bi-directional ball valve drain device 100 are important design parameters for user convenience, the bi-directional ball valve drain device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bi-directional ball valve drain device comprising:
a body comprised of a first end comprised of a first opening and a second end comprised of a second opening;
a handle;
a drain tube; and
a cap received by the drain tube.

2. The bi-directional ball valve drain device of claim 1, wherein the first opening is comprised of a threaded opening.

3. The bi-directional ball valve drain device of claim 1, wherein second opening is comprised of a threaded opening.

4. The bi-directional ball valve drain device of claim 1, wherein the drain tube is comprised of a first fastener.

5. The bi-directional ball valve drain device of claim 4, wherein the first fastener is comprised of a plurality of male threads or a plurality of female threads.

6. The bi-directional ball valve drain device of claim 1, wherein the cap is comprised of a second fastener.

7. The bi-directional ball valve drain device of claim 6, wherein the second fastener is comprised of a plurality of male threads or a plurality of female threads.

8. A bi-directional ball valve drain device comprising:
a body comprised of a first end comprised of a first opening and a second end comprised of a second opening;
a handle comprised of a tab;
a handle stop positioned on the body;
a drain tube; and
a cap received by the drain tube.

9. The bi-directional ball valve drain device of claim 8, wherein the first opening is comprised of a threaded opening.

10. The bi-directional ball valve drain device of claim 8, wherein second opening is comprised of a threaded opening.

11. The bi-directional ball valve drain device of claim 8, wherein the drain tube is comprised of a first fastener.

12. The bi-directional ball valve drain device of claim 11, wherein the first fastener is comprised of a plurality of male threads or a plurality of female threads.

13. The bi-directional ball valve drain device of claim 8, wherein the cap is comprised of a second fastener.

14. The bi-directional ball valve drain device of claim 13, wherein the second fastener is comprised of a plurality of male threads or a plurality of female threads.

15. A method of using a bi-directional ball valve drain device, the method comprising the following steps:
providing a bi-directional ball valve drain device comprised of a body comprised of a drain tube, a cap, a handle, a first end comprised of a first opening, and a second end comprised of a second opening;
attaching the bi-directional ball valve drain device to a plumbing waterline between a feed and a fixture;
rotating the handle a first direction to stop flow from the fixture into the bi-directional ball valve drain device;
removing the cap from the drain tube to allow liquid from the fixture to drain from the drain tube;
replacing the cap onto the drain tube;
rotating the handle a second direction to stop flow from the feed into the bi-directional ball valve drain device;
removing the cap from the drain tube to allow liquid from the feed to drain from the drain tube;
replacing the cap onto the drain tube; and
rotating the handle in the first direction such that the bi-directional ball valve device is placed in-line with the feed and the fixture such that a liquid can flow through the bi-directional ball valve device from the feed to the fixture.

16. The method of using a bi-directional ball valve drain device of claim 15, wherein the first direction is clockwise.

17. The method of using a bi-directional ball valve drain device of claim 15, wherein the second direction is counterclockwise.

18. The method of using a bi-directional ball valve drain device of claim 15, wherein the body is comprised of a handle stop.

19. The method of using a bi-directional ball valve drain device of claim 15, wherein the drain tube is comprised of a plurality of threads.

20. The method of using a bi-directional ball valve drain device of claim 15, wherein the first opening and the second opening are comprised of a threaded opening.
